(19) United States
(12) Patent Application Publication
(10) Pub. No.: US 2011/0195341 A1
(43) Pub. Date: Aug. 11, 2011

(54) Method for synthesizing Polymer Electrolyte, Polymer Electrolyte Membrane, and Solid Polymer Electrolyte Fuel Cell

(76) Inventor: Yukihisa Katayama, Aichi (JP)

(21) Appl. No.: 13/125,061

(22) PCT Filed: Oct. 14, 2009
(86) PCT No.: PCT/JP2009/067760

§ 371 Date: Apr. 20, 2011

(30) Foreign Application Priority Data
Oct. 22, 2008 (JP) 2008272141

(51) Int. Cl. H01M 8/10; C08J 5/20

(52) U.S. Cl. 429/494; 521/30

(57) ABSTRACT

An object of the present invention is to provide a method that is applicable to the production of a polymer electrolyte having high ion-exchange capacity, uniform crosslinking points and improve ionic conductivity, unlike conventional methods.

A method for synthesizing a polymer electrolyte comprises:
1^{st} step of maintaining a polymer having sulfonic acid groups and sulfonyl halide groups within the molecule at 0° C. or less in the presence of a base; and
2^{nd} step of carrying out a crosslinking reaction between the polymer prepared in the 1^{st} step and a cross-linking agent having one or more types of functional group selected from the group consisting of a disulfonyl amide group, a diamine group, a diol group and a dithiol group in an organic solvent.

### TECHNICAL FIELD

The present invention relates to a method for synthesizing a polymer electrolyte that has uniform crosslinking points, causes few side reactions, and has high ion-exchange capacity, a polymer electrolyte membrane comprising the polymer electrolyte, and a solid polymer electrolyte fuel cell.

### BACKGROUND ART

Solid polymer electrolytes are solid polymer materials having electrolyte groups such as sulfonic acid groups in a polymer chain. Since solid polymer electrolytes have properties to strongly bind to specific ions and to selectively permeate positive or negative ions, they are formed into particles, fibers, or membranes and used for various applications such as electrodialysis, diffusion dialysis, and battery diaphragms.

For example, fuel cells generate an electrical energy that is directly converted and obtained from a chemical energy of a fuel such as hydrogen or methanol through electrochemical oxidation of the fuel in the cells. In recent years, fuel cells have been attracting attention as sources of clean electrical energy supply. In particular, a solid polymer electrolyte fuel cell in which a proton exchange membrane is used as an electrolyte enables high power density and low-temperature operation. Thus, such solid polymer electrolyte fuel cell is expected as a power source for electrical vehicles.

However, fluorine electrolytes represented by perfluorosulfonic acid membranes have extremely high chemical stability because of their C—F bonds. They are thus used as, in addition to the above-described solid polymer electrolyte membranes for fuel cells, water electrolysis, or brine electrolysis, solid polymer electrolyte membranes for hydrohalic acid electrolysis. Furthermore, such fluorine electrolytes are widely applied to humidity sensors, gas sensors, oxygen concentrators, and the like with the use of proton conductivity.

A fluorine membrane is mainly used as an electrolyte membrane of a fuel cell, which has perfluoroalkylene as the main skeleton and partially has perfluoro vinyl ether side chains having ion-exchange groups such as a sulfonic acid group and a carboxylic acid group at the end thereof. Fluorine electrolyte membranes represented by perfluorosulfonic acid membranes have very high chemical stability, so that they are especially acclaimed as electrolyte membranes to be used under harsh conditions. Known examples of such fluorine electrolyte membranes include Nafion membrane (trademark, Du Pont), Dow membrane (Dow Chemical), Aciplex membrane (trademark, Asahi Kasei Corporation), and Flemion membrane (trademark, Asahi Glass Co., Ltd.).

However, a conventionally proposed perfluorosulfonic acid-based solid electrolyte membrane has drawbacks such that it is produced with difficulty and very expensive. Moreover, perfluorosulfonic acid electrolytes are problematic, for example, in that their heat resistance, drug resistance, and ion conductivity are insufficient, and they cannot sufficiently cope with high-temperature operation of fuel cells.

Therefore, it has been desired to develop ion conductive and ion-exchange materials as alternatives for perfluorosulfonic acid electrolytes. For example, polymer electrolytes for fuel cells are required to have high ion-exchange capacity. However, if they have high ion-exchange capacity, they are swollen with or solubilized in water. Hence, prevention of such swelling and solubilization in water has been attempted by crosslinking polymers.

The following WO99/61141 pamphlet discloses a method for producing crosslinking polymers comprising a step of: i) crosslinking polymers having pendant acid halide groups through reaction with a cross-linking agent that binds to one or more acid halide groups to give one or more groups having pKa <5, or ii) crosslinking polymers having pendant amide groups with the use of a cross-linking agent that binds to one or more amide groups to give one or more groups having pKa <5. Specifically, the document discloses, as such cross-linking agent in step i), ammonia, ammonium, NH₂SO₂RSO₂NH₂ (wherein, R denotes a substituted or unsubstituted alkyl, substituted or unsubstituted aryl, or substituted or unsubstituted heteroatom functional group), NH₂SO₂(CF₂)₄SO₂NH₂, and NH₂SO₂(C₆H₄Cl₂)SO₂NH₂. The document discloses, as such cross-linking agent in the step ii), formula XSO₂RSO₂X (wherein X denotes halogen, R denotes a substituted or unsubstituted alkyl, substituted or unsubstituted aryl, or substituted or unsubstituted heteroatom functional group).

In a preferred embodiment disclosed in WO99/61141, a homogeneous film is casted from a THF solution of a mixture of PEEK-SO₂Cl or polysulfone-SO₂Cl and the cross-linking agent NH₂SO₂CF₂CF₂CF₂CF₂SO₂NH₂. PEEK-SO₂Cl or polysulfone-SO₂Cl is obtained by chlorosulfonation of PEEK or polysulfone. Through immersion of a membrane in a basic solution such as a triethyl amine or NaOH aqueous solution, a reaction takes place between sulfonamide and sulfonyl chloride, so that strong acid bis(sulfonyl) imine is formed. Furthermore, a sulfonyl chloride group that does not react with a cross-linking agent is hydrolyzed into a sulfonic acid group.

Regarding PEEK polymers with sulfonyl halide groups introduced thereinto, gelatinization by crosslinking of such polymers through a disulfonyl amide formation reaction after film formation results in the following problems.

1) Brittleness is high at high acid density, so that film formation is difficult. Thus, such polymers cannot be applied to high-acid-density (>2.5 mmol/g) materials that cannot be formed into films.
2) A base reagent has low solubility in a solvent (for polymer dissolution) required for this reaction, so that formation of homogenous gel is difficult (the mixture should be stirred or left to stand for long time, and the degree of crosslinking differs between the exterior part and the interior part of the film).
3) Proton-conducting groups (precursors) are consumed depending on the crosslinking reaction, so that acid density decreases when another applicable crosslinking method based on high acid density is employed.

Also, for the purpose of obtaining a highly heat-resistant polymer electrolyte excellent in heat resistance, oxidation resistance, and conductive property, the following JP Patent Publication (Kokai) No. 2000-188013 A discloses that perfluoro-based polymer compounds are crosslinked with strong acid crosslinking groups through: a crosslinking reaction of perfluoro-based polymer compounds having functional groups that can serve as strong acid crosslinking groups; or a crosslinking reaction of such perfluoro-based polymer compounds with a crosslinking agent having functional groups that can serve as strong acid crosslinking groups such as sulfonamide on the end thereof. Examples of such strong acid crosslinking groups include bis-sulfonylimide, sulfonylcarbonylimide, bis-carbonylimide, and bis-sulfonylmethylene.

In the case of the polymer electrolyte disclosed in JP Patent Publication (Kokai) No. 2000-188013 A, it is difficult to realize uniform crosslinking points since crosslinking is performed for solid polymers.

### DISCLOSURE OF THE INVENTION

### Objects to be Achieved by the Invention

In view of the problems of the methods for producing polymer electrolytes as disclosed in WO99/61141 Pamphlet and JP Patent Publication (Kokai) No. 2000-188013 A above, an object of the present invention is to provide a method that is applicable for production of a polymer electrolyte having high ion-exchange capacity and can provide uniform crosslinking points compared with conventional methods to improve ionic conductivity. Also, another object of the present invention is to realize a good solid polymer electrolyte fuel cell using the polymer electrolyte.

### Means for Attaining the Objects

As a result of intensive studies to achieve the above objects, the present inventors have discovered that the above objects can be achieved by carrying out crosslinking during a step of solution reaction. Thus, the present invention has been achieved.

First, the present invention relates to a method for synthesizing a polymer electrolyte, comprising:

1^{st} step of maintaining a polymer having sulfonic acid groups and sulfonyl halide groups within the molecule at 0° C. or less in the presence of a base; and
2^{nd} step of carrying out a crosslinking reaction between the polymer prepared in the 1^{st} step and a cross-linking agent having one or more types of functional group selected from the group consisting of a disulfonyl amide group, a diamine group, a diol group and a dithiol group in an organic solvent.

In the 1^{st} step, a polymer having sulfonic acid groups and sulfonyl halide groups is maintained in the presence of a base, so that the sulfonic acid group is converted into a sulfonate group. The sulfonic acid group is dissolved with difficulty in an organic solvent. Hence, in the 2^{nd} step, crosslinking points are varied, so that it is difficult to prepare a homogenous electrolyte (gel). According to the present invention, the sulfonic acid group is converted into a sulfonate group that is soluble in an organic solvent, so that crosslinking points are less likely to be varied and a homogenous electrolyte (gel) can be prepared.

Also, the temperature is maintained at 0° C. or less to allow prevention of a reaction by which a sulfonyl halide group serving as a crosslinking point in the 2^{nd} step is converted to a sulfonate group not serving as a crosslinking point. When the temperature is simply maintained at 0° C. or less, by-products (e.g., HCl or H₂SO₄) are not neutralized and remain in the polymer. If the resultant is used as an electrolyte, durability is lowered because of the remaining by-products. Hence, the polymer should be maintained at 0° C. or less in the presence of a base.

In the 1^{st} step above, a polymer (insoluble in an organic solvent) having sulfonic acid groups (10% to 20%) and sulfonyl halide groups (80% to 90%) can be converted to a polymer (soluble in an organic solvent) having sulfonate groups (20% to 30%) and sulfonyl halide groups (70% to 80%).

Furthermore, in the 2″ step, the polymer having the sulfonate groups and the sulfonyl halide groups is crosslinked with a cross-linking agent having a disulfonyl amide group, a diamine group, a diol group, or dithiol group in an organic solvent. The sulfonyl halide group has higher reactivity than the sulfonate group. Accordingly, the cross-linking agent conducts a crosslinking reaction selectively with a sulfonyl halide group. At this time, the sulfonyl halide group can perform crosslinking without consuming any sulfone groups that provides proton conduction. Thus, high proton conductivity and crosslinking are provided.

Also, the 2^{nd} step is performed in an organic solvent, so that a crosslinking reaction is conducted. If water is contained, a sulfonyl halide group that serves as a crosslinking point and water approach each other, and then it becomes impossible for the cross-linking agent to come closer to the sulfonyl halide group, so that no crosslinking reaction takes place.

As a result of the 1^{st} and 2^{nd} step described above, a uniformly crosslinked electrolyte having high ion-exchange capacity can be obtained.

In the 1^{st} step above of the present invention, preferably the polymer is maintained at 0° C. or less in the presence of a weak base and filtrated under reduced pressure at a rate of 200 ml/min or higher. Accordingly, by-products can be rapidly separated.

In the 1^{st} step above of the present invention, degassing is preferably carried out. Accordingly, gasified by-products can be removed.

In the present invention, the above polymer having sulfonic acid groups and sulfonyl halide groups within the molecule is preferably a non-fluorine polymer having an aromatic main chain. Previously, an electrolyte that can withstand harsh operation conditions because of its aromatic main chain, such as a polyphenylene structure for which achievement of higher acid density, solubilization, and crosslinking have been problematic can be obtained.

Also, the above polymer having sulfonic acid groups and sulfonyl halide groups within the molecule can be obtained by treating a polymer with a halo-sulfonic agent. Preferred examples of such halo-sulfonic agent include chlorosulfuric acid and chlorosulfuric acid+thionyl chloride.

Second, the present invention relates to a solid polymer electrolyte membrane comprising a polymer electrolyte that is synthesized by the above method. The solid polymer electrolyte membrane of the present invention can be used for various applications that require durability and high ion-exchange capacity. Specifically, the solid polymer electrolyte membrane can be preferably used for fuel cells, water electrolysis, halogenated hydroacid electrolysis, brine electrolysis, oxygen condensers, humidity sensors, gas sensors, and the like.

Third, the present invention relates to a solid polymer electrolyte fuel cell produced using the above polymer electrolyte and/or solid polymer electrolyte membrane. By the use of the polymer electrolyte and/or solid polymer electrolyte membrane of the present invention for fuel cells, fuel cells having good durability and good ion conductivity can be obtained.

This description includes part or all of the contents as disclosed in the description and/or drawings of Japanese Patent Application No. 2008-272141, which is a priority document of the present application.

### Effects of the Invention

The synthesis method of the present invention involves a homogenous reaction, unlike conventional methods. Hence, a synthesized polymer electrolyte has uniform crosslinking points. Therefore, ionic conductivity can be improved. Also, crosslinking is possible in a solvent, even in the case of a high-acid-density electrolyte, to which conventional methods have been inapplicable.

### BRIEF DESCRIPTION OF DRAWINGS

FIG. 1 shows an example of the reaction scheme of the present invention.

### BEST MODE FOR CARRYING OUT THE INVENTION

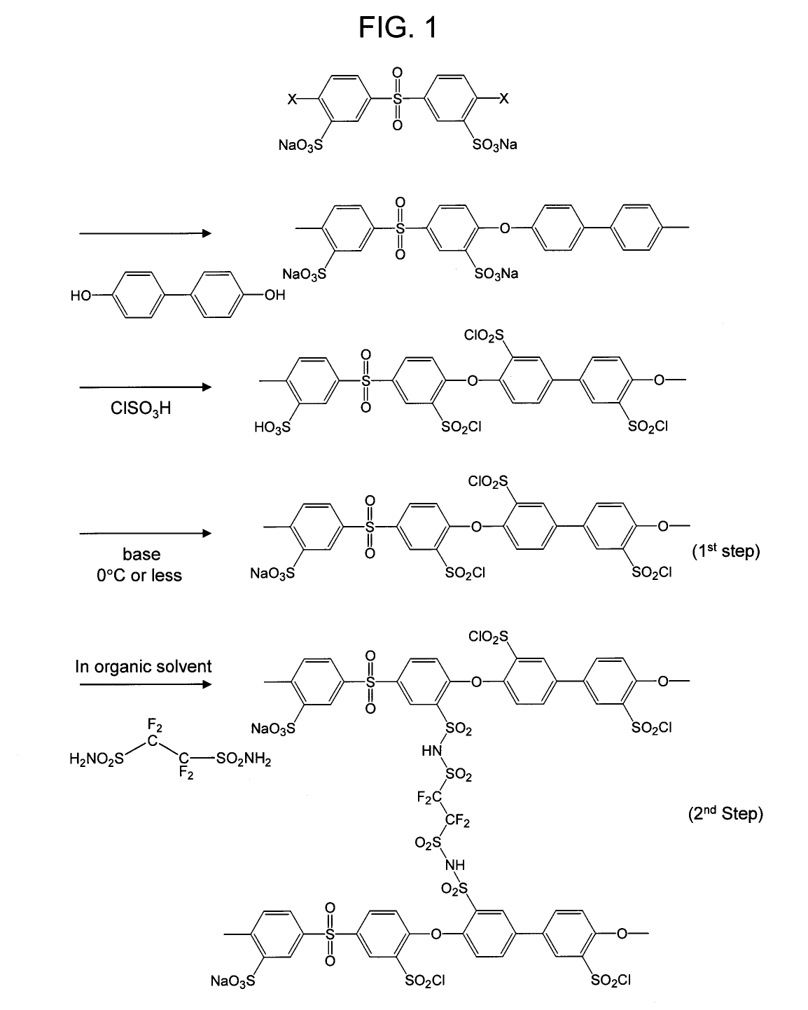

FIG. 1 shows an example of the reaction scheme of the present invention.

Before the 1^{st} step, some of sulfonic acid groups (alkali metal substitution) in a polymer are converted to sulfonyl halide groups using chlorosulfonic acid. Before and after the reaction of the 1^{st} step, approximately,

—SO₂Cl:—SO₃H=80 to 90:20 to 10

is converted to

—SO₂Cl:—SO₃Na=70 to 80:30 to 20.

By adjusting to (weak) alkaline condition, —SO₃H can be converted to —SO₃Na and contaminants adhering to electrolyte materials and lowering durability such as HCl and H₂SO₄ can be neutralized and rendered harmless. Here, an —SO₃H group has proton conductivity, but it is insoluble in an organic solvent and does not serve as a crosslinking point in the 2^{nd} step. —SO₃Na generated after the reaction has proton conductivity and does not serve as a crosslinking point, but it is soluble in an organic solvent. —SO₃ Na prevents degradation of —SO₂Cl, which serves as a crosslinking point in the 2^{nd} step. A large amount of —SO₂Cl, which serves as a crosslinking point, leads to insolubility in water and improved durability.

As a result, acid density that is two times greater than that of a conventional electrolyte membrane can be realized, leading to improvement in fuel cell performance. It becomes possible to synthesize a precursor with which an electrolyte that is insoluble in water, despite having high acid density, can be formed.

In FIG. 1, aromatic polyether sulfone is used as an example of a main chain. A wide range of known heat-resistant polymers can be used as main chains of polymers having functional groups to be used in the present invention. Specific preferred examples thereof include one or more types selected from the group consisting of polyphenylene, polynaphthalene, aromatic polyether, aromatic polythioether, aromatic polysulfone, aromatic polyether sulfone, aromatic polymers linked via alkylene groups, aromatic polyamide, aromatic polyester, aromatic polyimide, aromatic polyetherimide, aromatic polyamide-imide, aromatic polyketone, aromatic polyether ether ketone, aromatic polyhydrazide, aromatic polyimine, polyoxadiazole, polybenzoxazole, polybenzimidazole, alkyl substituted compounds thereof, and hydroxy-group-substituted compounds thereof.

Linking groups other than aromatic groups may be absent in the main chain of a polymer having functional groups. However, the presence of such linking groups ensures the heat resistance of the main chain. Specific preferred examples of such linking groups include one or more types selected from the group consisting of an ether group, a carbonyl group, a thioether group, a sulfone group, an amide group, a bis sulfonimide group (—SO₂NHSO₂—), a sulfoncarbonimide group (—SO₂NHCO—), a biscarbonimide group (—CONHCO—), and an alkylene group.

Preferred examples of an organic solvent to be used in the present invention include cyclic hydrocarbon, cyclic ether, and cyclic ketone.

The present invention will be further described in the following Examples and Comparative examples.

### Example 1

A polyether sulfone-based sulfonated polymer shown in FIG. 1 was added in small amounts to a 100-ml eggplant flask containing 50 ml of chlorosulfuric acid (NACALAI TESQUE, INC.) while maintaining a temperature of 0° C. After warming to room temperature, complete dissolution was confirmed and then the temperature was raised to 110° C. After 6 hours, the temperature was lowered to 70° C., 10 ml of thionyl chloride (NACALAI TESQUE, INC.) was added while maintaining the temperature, and then the resultant was held for 1 hour while refluxing.

After cooling to room temperature, the resultant was added dropwise to a large amount of ice water and 10 wt % baking soda and precipitation was formed again. After completing the dropwise addition, an appropriate amount of baking soda was added again, and pH was adjusted to weak alkaline conditions, pH 7 to 8, so that remaining acids was completely removed. The resultant was subjected to separation by filtration under reduced pressure while rapid washing with a large amount of ice water. It was then subjected to vacuum drying at 80° C. for 12 hours. Thus, a white precipitate was obtained.

The molecular weight and dispersion value were 1.71×10⁴ and 1.75, respectively, as measured by DMF-GPC. A portion (1.0 g) of the resultant was weighed and dissolved together with 0.01 g of hexafluoro propyl disulfonyl amide (H₂NSO₂(CF₂)₃SO₂NH₂) into 10 ml of dehydrated cycloheptanone. The resultant was casted on a smooth glass plate. Then the plate was dried and then immersed in triethyl amine (NACALAI TESQUE, INC.). Gelatinization was completed within 5 to 20 minutes.

After the resultant was washed in a 10 wt % aqueous sodium hydroxide solution for 10 hours, the gel alone was removed and then washed with a 4N hydrochloric acid solution for 12 hours. After substitution with —SO₃H, the resultant was washed with pure water for 12 hours and then subjected to vacuum drying at 80° C. for 12 hours. Thus, a brown transparent gel with a thickness of 120 μm was obtained. The gel was cut into a predetermined shape and then set on a counter electrode. The electrode was placed within an incubator (ESPEC) and then maintained at 80° C. and 10% RH for 12 hours for measurement. Proton conductivity was 8.01×10⁻⁴ S/cm (ion-exchange capacity: 4.97 mmol/g).

### Example 2

1 g of a polymer (number average molecular weight: 24000) containing polyphenylene synthesized by a Diels-Alder reaction as a basic structure was added to a 50-ml eggplant flask containing a glass stirrer. Then, 20 ml of high purity concentrated sulfuric acid (>98%, Kanto Chemical Co., Inc.) was added and then the resultant was heated using a mantle heater to 290° C. After 3 hours of reaction, the temperature was cooled to room temperature. Then the resultant was added dropwise to 200 ml of dehydrated diethyl ether (Kanto Chemical Co., Inc.) cooled to −10° C. under an N₂ atmosphere, so that precipitation was carried out again. After 3 hours, powder was collected by filtration under reduced pressure, added again to 200 ml of dehydrated diethyl ether+dehydrated acetonitrile (volume ratio of 7:3) under an N₂ atmosphere, and then washed.

After 2 hours, filtration under reduced pressure was carried out and then vacuum drying was carried out at 60° C., so that a brownish-red powder (yield: >90%) was obtained by neutralization titration.

The resultant was converted to —SO₂Cl under the same conditions as those in Example 1, so that a gel with a thickness of 105 μm was obtained by similar techniques. Conductivity was measured by similar techniques. The proton conductivity was 9.21×10⁻⁵ S/cm (ion-exchange capacity: 3.81 mmol/g).

### Comparative Example 1

The polymer used in Example 1 was added to 20 ml of fuming sulfuric acid (30 wt %) in a 50-ml eggplant flask. Then the temperature was raised to 60° C. and maintained for 2 hours. After cooling to room temperature, the resultant was added dropwise to 500 ml of dehydrated diethyl ether (Kanto Chemical Co., Inc.) at −30° C. while vigorously stirring. After the precipitate was collected by filtration under reduced pressure, it was washed again with a mixture of dehydrated diethyl ether and dehydrated acetonitrile (volume ratio of 8:2). Filtration under reduced pressure was carried out again, so that a white precipitate was collected. This was subjected to 12 hours of vacuum drying at 80° C. The powder was water soluble and a film formed with the powder was very fragile. Thus, measurement of conductivity was impossible (ion-exchange capacity: 4.89 mmol/g).

### Comparative Example 2

The polymer synthesized in Example 2 was treated by the technique of Comparative example 1. Thus, a brownish-red precipitate was collected and then subjected to 12 hours of vacuum drying at 80° C. The powder was water soluble and could not be formed into a film, and it remained in the form of powder. Thus, measurement of conductivity was impossible (ion-exchange capacity: 3.79 mmol/g).

### Comparative Example 3

SUMIKAEXCEL (3600P, 4.00 g, Sumitomo Chemical Co., Ltd.) was added to 20 ml of fuming sulfuric acid (30 wt %) in a 50-ml eggplant flask while stirring. The temperature was raised to 60° C. and maintained for 2 hours. After cooling to room temperature, the resultant was added dropwise to 500 ml of dehydrated diethyl ether (Kanto Chemical Co., Inc.) cooled at −30° C. while vigorously stirring. The precipitate was collected by filtration under reduced pressure, washed again with a mixture of dehydrated diethyl ether and dehydrated acetonitrile (volume ratio of 8:2). Filtration under reduced pressure was carried out again and a white precipitate was collected. This was subjected to vacuum drying at 80° C. for 12 hours. After dissolved in pure water, the resultant was casted on a smooth glass plate. The dry plate was set on a counter electrode, and the electrode was placed within an incubator (ESPEC). It was maintained at 80° C. and 10% RH for 12 hours and then conductivity was measured. Conductivity was 1.03×10⁻⁶ S/cm (ion-exchange capacity: 2.61 mmol/g).

### Comparative Example 4

1 g of the polymer obtained in Example 2 was added to a 50-ml three-neck eggplant flask (with a dropping funnel) containing a stirrer, followed by argon substitution. 20 ml of dehydrated methylene chloride (NACALAI TESQUE, INC.) was added and then the mixture was stirred for 3 hours. Thus, a homogenous solution was prepared and then cooled to −30° C. Chlorosulfuric acid (1.17 ml) (with a target concentration of 3.0 mmol/g) was dissolved in dehydrated chloroform (NACALAI TESQUE, INC.) to 5 wt % and then slowly added dropwise while stirring. The polymer was precipitated as a precipitate in the liquid during dropwise addition. The precipitate was removed by filtration under reduced pressure, washed with 100 ml of a 10 wt % aqueous sodium hydroxide solution, sufficiently washed with pure water, and then subjected to vacuum drying. The resultant was dissolved in DMAc (NACALAI TESQUE, INC.) at 15 wt %, casted on a smooth glass plate, and then subjected to acid treatment with 1 N hydrochloric acid. Thus, a yellow transparent film was obtained and then set on a counter electrode. The electrode was placed within an incubator (ESPEC) and then held at 80° C. and 10% RH for 12 hours. Conductivity was then measured. Conductivity was 9.67×10⁻⁷ S/cm (ion-exchange capacity: 1.96 mmol/g).

Table 1 below shows the property of each sample obtained in Examples and Comparative examples.

TABLE 1

| | Ion-exchange | | Conductivity |
|---|---|---|---|
| | capacity | | (S/cm) |
| Sample name | (mmol/g) | Film status | @80° C. · 10% RH |
| Example 1 | 4.97 | Good, | 8.01 × 10⁻⁴ |
| | | no crack | |
| Example 2 | 3.81 | Good, | 9.21 × 10⁻⁵ |
| | | cracks on ends | |
| Comparative | 4.89 | Powder, | Unmeasurable |
| example 1 | | No film formation | |
| Comparative | 3.79 | Powder, | Unmeasurable |
| example 2 | | No film formation | |
| Comparative | 2.61 | Good, | 1.03 × 10⁻⁶ |
| example 3 | | no crack | |
| Comparative | 1.96 | Good, | 9.67 × 10⁻⁷ |
| example 4 | | no crack | |

### INDUSTRIAL APPLICABILITY

A polymer electrolyte synthesized by the method of the present invention has uniform crosslinking points and improved ionic conductivity. Also, crosslinking is possible in a solvent even in the case of a high acid density electrolyte, to which conventional methods have been unapplicable. Accordingly, an electrolyte membrane comprising a polymer electrolyte synthesized by the present invention can be broadly used for fuel cells, water electrolysis, halogenated hydroacid electrolysis, brine electrolysis, oxygen condensers, humidity sensors, gas sensors, and the like.

All publications, patents, and patent applications cited herein are incorporated herein by reference in their entirety.

1. A method for synthesizing a polymer electrolyte, comprising:
1^{st} step of maintaining a polymer having sulfonic acid groups and sulfonyl halide groups within the molecule at 0° C. or less in the presence of a base; and
2^{nd} step of carrying out a crosslinking reaction between the polymer prepared in the 1^{st} step and a cross-linking agent having one or more types of functional group selected from the group consisting of a disulfonyl amide group, a diamine group, a diol group and a dithiol group in an organic solvent.

2. The method for synthesizing a polymer electrolyte according to claim 1, wherein in the 1^{st} step, the polymer is maintained at 0° C. or less in the presence of a weak base and filtrated under reduced pressure at a rate of 200 ml/min or greater.

3. The method for synthesizing a polymer electrolyte according to claim 1, wherein in the 1^{st} step, degassing is carried out.

4. The method for synthesizing a polymer electrolyte according to claim 1, wherein the polymer having sulfonic acid groups and sulfonyl halide groups within the molecule has an aromatic main chain.

5. The method for synthesizing a polymer electrolyte according to claim 1, wherein the polymer having sulfonic acid groups and sulfonyl halide groups within the molecule is obtained by treating a polymer with a halo-sulfonic agent.

6. A solid polymer electrolyte membrane, comprising a polymer electrolyte synthesized by the method according to claim 1.

7. A solid polymer electrolyte fuel cell, comprising a polymer electrolyte synthesized by the method according to claim 1.

8. A solid polymer electrolyte fuel cell, comprising a polymer electrolyte membrane which comprises a polymer electrolyte synthesized by the method according to claim 1.
